(19) United States
(12) Patent Application Publication
(10) Pub. No.: US 2022/0280934 A1
(43) Pub. Date: Sep. 8, 2022

(54) DEVICE FOR TAKING A SAMPLE OF BIOLOGICAL LIQUID

(71) Applicant: IKI, CARBONNE (FR)

(72) Inventors: Guillaume JULIEN, MURET (FR); Morgane LEBLANC, TOULOUSE (FR); Bernard BOUISSOU, CUGNAUX (FR); Didier FABBRO, CARBONNE (FR); Julien CALVE, PLAISANCE DU TOUCH (FR); Philippe LUMBIERRES, CARBONNE (FR); Cyril CAUCHOIS, SAINT JULIEN SUR GARONNE (FR); Jean-Christophe CAU, TOULOUSE (FR)

(21) Appl. No.: 17/637,062

(22) PCT Filed: Sep. 16, 2020
(86) PCT No.: PCT/EP2020/075812

§ 371 Date: Feb. 21, 2022

(30) Foreign Application Priority Data
Sep. 17, 2019 (FR) 1910242

(51) Int. Cl. B01L 3/00

(52) U.S. Cl. CPC B01L 3/5023; B01L 2300/0825; B01L 2300/126; B01L 2400/0406

(57) ABSTRACT

A device to collect a biological liquid sample to be inserted into a portable reader to analyze the biological liquid. The device includes a strip, an absorbent assembly, a band and a housing having a housing bottom. The color-changing reactive elements are arranged one after the other on an upper face of the strip. The absorbent assembly includes a deposition portion on which the biological liquid is deposited thereon. The band to diffuse the biological liquid arranged over the top of the reactive elements. The strip is arranged on the housing bottom with a lower face of the strip facing the housing bottom. Each reactive element is arranged by transparency through the strip facing an opening in the housing bottom. A cover is arranged over the top of the band and includes a protruding pattern forming a pressing surface configured to press the band into contact with the reactive elements.

### TECHNICAL FIELD OF THE INVENTION

The present invention relates to a device for collecting a biological liquid sample. It applies, in particular, to a urine sample collection cartridge for the purpose of analysing urinary marker value.

### PRIOR ART

It is common, among health professionals, to be able to analyse a biological liquid sample such as urine or else saliva. It is known to use strips equipped with a few reactive elements whose colour may vary in contact with the biological liquid. After soaking the strip in the biological liquid, the reactive elements may change colour. A first known manner of reading colours and its interpretation is to detect the colour change with the naked eye and to interpret this change according to a table of correspondence of the colours to a concentration of compound in the biological liquid. Another manner consists in using, for a health professional, a bulky and expensive apparatus allowing analysing the strip comprising the reactive elements.

It has already been attempted to overcome this problem by offering the general public to themselves soak strips equipped with reactive elements in a jar comprising for example urine, and to themselves analyse with the naked eye, the colour change of the reagents and interpret the colours according to the instructions provided with the strip.

This home solution does not always reliably inform the user, the user may have difficulty discerning a colour change relative to the instructions, the time of soaking of the strip in the biological liquid not being necessarily mastered by the user, the latency time between the end of soaking and the interpretation of the colours of the reagents also not always being mastered by the user.

### Presentation of the Invention

The present invention aims at overcoming these drawbacks with a completely innovative approach.

To this end, according to a first aspect, the present invention relates to a device for collecting a biological liquid sample intended to be able to be inserted into a portable reader for analysing the biological liquid, the device comprising a transparent or translucent strip extending along a longitudinal axis and comprising, on its upper face, a plurality of colour-changing reactive elements arranged one after the other along the longitudinal axis; an absorbent assembly extending along the longitudinal axis and comprising a biological liquid deposition portion; a band for the diffusion of the biological liquid arranged over the top of the plurality of reactive elements; a housing extending along the longitudinal axis between two lateral ends, the housing comprising: a housing bottom, the strip being arranged in the housing bottom, the lower face of the strip being arranged facing the housing bottom, each reactive element being arranged by transparency through the strip facing an opening of the housing bottom; an upper cover arranged over the top of the diffusion band, and comprising at least one protruding pattern forming a first pressing surface configured to press the diffusion band into contact with the plurality of reactive elements; an access opening configured to provide access to the biological liquid deposition portion.

The invention is implemented according to the embodiments and the variants exposed below, which are to be considered individually or according to any technically operative combination.

Advantageously, the biological liquid deposition portion can be arranged through the access opening. The absorbent assembly may be a single blotting paper.

Advantageously, the biological liquid deposition portion may comprise an absorbent reservoir band distinct from the diffusion band; the housing may comprise a second pressing surface configured to press at least one contact portion of the absorbent reservoir band into contact with a contact pad of the diffusion band.

Advantageously, the absorbent reservoir band and the diffusion band are arranged generally longitudinally one after the other, the reservoir band can be configured to be movable in translation along the longitudinal axis, the contact portion can be arranged at the end of the absorbent reservoir band; the contact portion can be configured to hit the second pressing surface by pushing, along the longitudinal axis, of the absorbent reservoir band so as to be brought into contact with the contact pad of the diffusion band.

Advantageously, the diffusion band and the absorbent reservoir band can comprise respectively a diffusion blotting paper and a reservoir blotting paper distinct from the diffusion blotting paper, the reservoir blotting paper comprising a liquid absorption feature greater than that of the diffusion blotting paper.

Advantageously, the diffusion band can comprise a plurality of mounting pads arranged successively along the longitudinal axis, each reactive element being arranged under a single mounting pad, the diffusion band can comprise a material recess between each of the mounting pads.

Advantageously, the access opening can be arranged on one of the lateral ends of the housing. The housing may comprise two opposite longitudinal walls inside the housing forming a guideway cooperating with a removable support of the absorbent assembly, the removable support being configured to be inserted into the housing through the access opening.

Alternatively, the access opening can be arranged on the cover of the housing or on the housing bottom.

### BRIEF DESCRIPTION OF THE FIGURES

Other advantages, aims and features of the present invention emerge from the following description made, for the purpose of explanation and without limitation, with reference to the appended drawings, in which:

FIG. 1 is a perspective schematic view of a biological liquid sample analysis system comprising a biological liquid sample collection device according to a first embodiment of the invention, and a reader for analysing the sample of the biological liquid collected by the device.

FIG. 2 is a perspective exploded schematic top view of the biological liquid sample collection device according to the first embodiment of the invention.

FIG. 3 is a perspective exploded schematic bottom view of the biological liquid sample collection device according to the first embodiment of the invention.

FIG. 4 is a perspective schematic top view of a biological liquid sample collection device according to a second embodiment of the invention and according to a first positioning of the biological liquid deposition portion.

FIG. 5 is a perspective exploded schematic view of the device of FIG. 4.

FIG. 6 is a perspective exploded schematic bottom view of the device of FIG. 4.

FIG. 7 is a perspective schematic top view by transparency of the device of FIG. 4.

FIG. 8 is a schematic longitudinal sectional view of the device of FIG. 4.

FIG. 9 is a perspective schematic top view of the biological liquid sample collection device according to the second embodiment of the invention and according to a second positioning of the biological liquid deposition portion.

FIG. 10 is a perspective schematic top view by transparency of the device of FIG. 9.

FIG. 11 is a schematic longitudinal sectional view of the device of FIG. 9.

FIG. 12 is a perspective schematic top view of a biological liquid sample collection device according to a third embodiment of the invention.

FIG. 13 is a perspective schematic top view of a collection device of FIG. 12 in which the biological liquid deposition portion is extracted from the housing of the device.

FIG. 14 is a perspective exploded schematic top view of the collection device of FIG. 13.

FIG. 15 is a perspective exploded schematic top view of the housing bottom and of a strip comprising the reactive elements of FIG. 14.

FIG. 16 is a schematic longitudinal sectional view of the device of FIG. 12.

FIG. 17 is an enlargement of a portion of FIG. 16.

FIG. 18 is a perspective schematic top view of a biological liquid sample collection device according to a fourth embodiment of the invention.

FIG. 19 is a perspective schematic top view of a collection device of FIG. 18 in which the biological liquid deposition portion is extracted from the housing of the device.

FIG. 20 is a perspective exploded schematic top view of the collection device of FIG. 19.

FIG. 21 is a perspective schematic view of a system for analysing a biological liquid sample according to the fourth embodiment comprising a reader for analysing the sample of the biological liquid and the biological liquid sample collection device which is not inserted into the analysis reader.

FIG. 22 is a perspective schematic view of the system of FIG. 21 in which the biological liquid sample collection device is first inserted with a first push into the reader for analysing the sample of the biological liquid.

FIG. 23 is a perspective schematic view of the system of FIG. 21 in which the biological liquid sample collection device is inserted with a second push into the reader for analysing the sample of the biological liquid.

### DESCRIPTION OF THE EMBODIMENTS

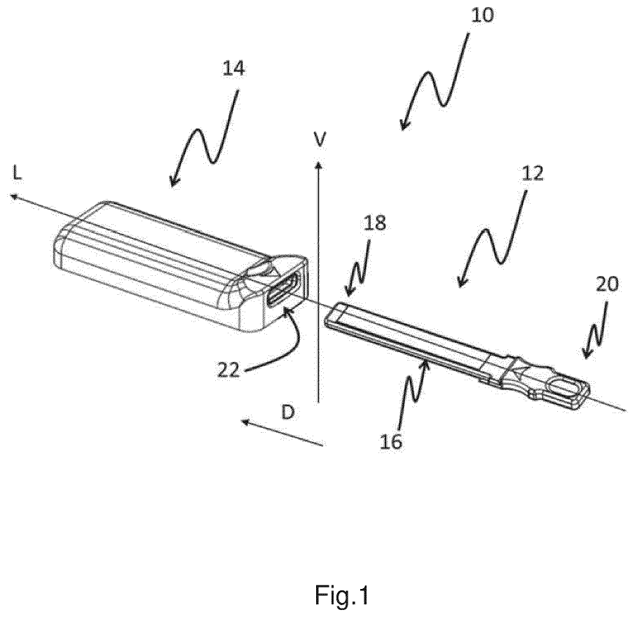

According to FIG. 1, a system 10 for analysing a biological liquid sample comprises a device 12, or cartridge, for collecting a biological liquid sample and a portable reader 14 for analysing a biological liquid sample. For the purposes of positioning the elements with each other, and without limitation with regard to the overall orientation of the collection device 12 and the reader 14, left and right orientations are defined along a longitudinal axis L and top and bottom, or upper and lower, orientations are defined along a vertical axis V. The biological liquid sample collection device 12 is intended to be inserted into the portable reader 14 for analysing the biological liquid. The collection device 12 comprises a housing 16 extending generally along the longitudinal axis L between two left and right lateral ends 18, 20, the housing 16 being configured to be inserted in translation, in a longitudinal direction D, into an opening 22 of the reader 14. By way of non-limiting example, it has been defined that a collection device 12 of about 10 centimetres in length along the longitudinal axis L, of a thickness less than one centimetre along the vertical axis V and of a width along an axis transverse to the longitudinal axis L to within one centimetre could correspond to the need.

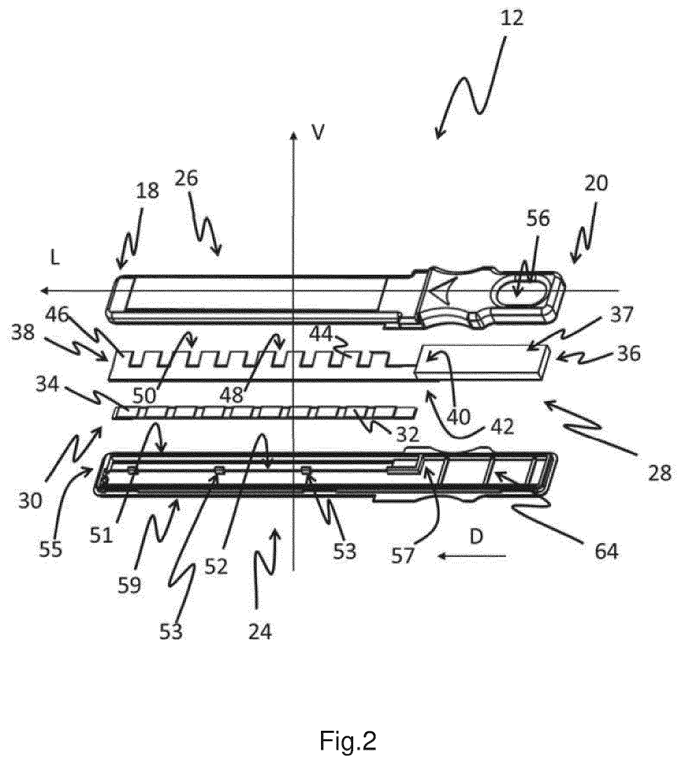

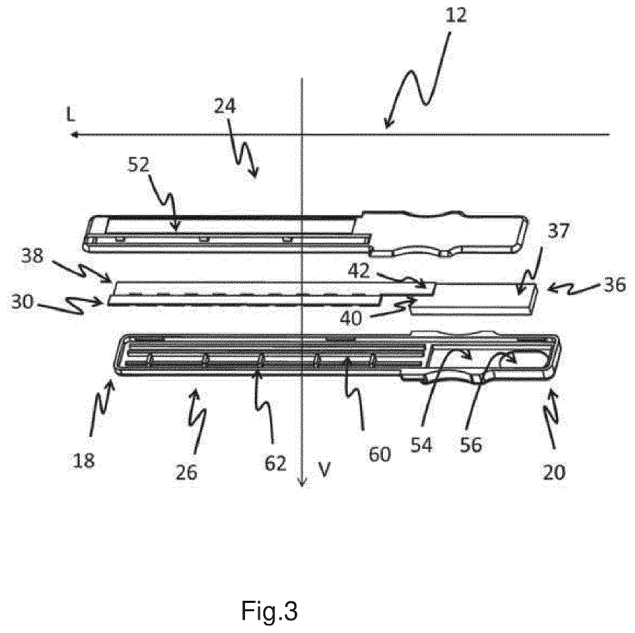

According to FIG. 2 and FIG. 3, and according to a first embodiment, the collection device 12 of FIG. 1 comprises the housing 16 comprising a lower element or housing bottom 24 and an upper element or cover 26 allowing closing the top of the housing 16. The collection device 12 comprises an absorbent assembly 28, extending along the longitudinal axis L, configured to be arranged in the housing 16. The collection device 12 also comprises a strip 30 extending longitudinally and comprising, on the upper face thereof, a plurality of colour-changing reactive elements 32, 34 arranged one after the other along the longitudinal axis L. In the context of the invention, the term “colour change” should mean the evolution of the colour of a reactive element 32, 34 when it is brought into contact with a biological liquid, for example and without limitation, of a change in the colour from orange to blue for an indication of acidity (or else denoted ‘pH’) of the biological liquid, but also of an appearance of colour, that is to say from the white aspect of a reactive element to a pink colouration when detecting nitrites in the biological liquid in contact with the appropriate reactive element 32, 34. By way of non-limiting example, and according to the dimensions of the previously indicated collection device 12, a strip 30 which may comprise ten reactive elements 32, 34 is compatible with the housing 16 and is suitable for a sufficiently exhaustive biological liquid analysis.

The absorbent assembly 28, such as an absorbent paper capable of absorbing a liquid, has the role of receiving the biological liquid and of diffusing it in contact with the reactive elements 32, 34. To this end, according to this first embodiment, the absorbent assembly 28 comprises an absorbent reservoir band 36 provided for the deposition of biological liquid, and a diffusion band 38 configured to diffuse, by capillary action, the biological liquid previously deposited on the absorbent reservoir band 36 on the reactive elements 32, 34 of the strip 30. The absorbent reservoir band 36 therefore comprises at least one portion configured to be in contact with the diffusion band 38.

To this end, preferably, the diffusion band 38 and the absorbent reservoir band 36 comprise respectively a diffusion blotting paper and a reservoir blotting paper distinct from the diffusion blotting paper, the reservoir blotting paper comprising a liquid absorption feature greater than that of the diffusion blotting paper. The reservoir blotting paper should allow an absorption of an amount of biological liquid necessary for the analysis, and also allow a rapid transfer of the biological liquid to the diffusion blotting paper. By way of non-limiting example, it was found that a reservoir blotting paper with a thickness between 2 and 3 millimetres, and with a liquid absorption feature comprised between 200 and 300 milligrams of liquid per square centimetre could be suitable for the collection device 12, this type of reservoir blotting paper comprising a liquid advance speed comprised between 3 and 5 cm for a time of ten seconds. It has also been found that a diffusion blotting paper comprising a thickness less than one millimetre, preferably comprised between 0.2 and 0.6 millimetres, and an absorption capacity comprised between 20 and 40 milligrams of liquid per square centimetre could be suitable for the collection device 12, this type of diffusion blotting paper comprising a liquid advance speed comprised between 0.5 and 1.5 cm for a time of 10 seconds.

According to the first embodiment of FIG. 2 and of FIG. 3, the absorbent reservoir band 36 and the diffusion band 38 are arranged generally longitudinally one after the other. The absorbent reservoir strip 36 extending from the right lateral end 20 of the housing 16 to the second end thereof forming a contact portion 40, the diffusion band 38 extending from the left lateral end 18 of the housing 16 to the second end thereof forming a contact pad 42. The contact portion 40 is configured to be in contact with the diffusion band 38. The contact portion 40 is arranged over the top of the contact pad 42 of the end of the diffusion band 38.

The strip 30 is arranged below the diffusion band 38. More particularly, the upper face of the strip 30, equipped with the plurality of reactive elements 32, 34 faces the lower face of the diffusion band 38 such that the diffusion band 38 can bear on the reactive elements 32, 34, allowing a reaction of the reactive elements 32, 34 in contact with the biological liquid diffused by capillary action through the diffusion band 38.

According to the first embodiment represented in FIG. 2 and in FIG. 3, the diffusion of the biological liquid through the diffusion band is performed from the contact portion 40 of the absorbent reservoir band 36 in contact with the contact pad 42 from the end of the diffusion band 38, to the end opposite the contact pad 40 of the diffusion band 38. To this end, when the reactive elements 32, 34 are in contact with the diffusion band 38, they are in turn in contact with the biological liquid being diffused in the longitudinal direction D. In particular, and in order to avoid pollution phenomena, or contamination, between successive reactive elements 32, 34, the diffusion band 38 comprises a plurality of mounting pads 44, 46 arranged successively along the longitudinal axis L and separated from each other along the longitudinal axis L by a material recess 48, 50 of the diffusion band 38. Each reactive element 32 is configured to be arranged in contact with a single mounting pad 44, the diffusion band 38 comprising a material recess between each of the mounting pads 44, 46.

Preferably and as represented in FIG. 2 and FIG. 3, the mounting pads 44, 46 are arranged along a longitudinal edge of the diffusion band 38, thus forming a series of mounting pads 44, 46 in the form of successive slots.

This embodiment allows the biological liquid to diffuse along the other longitudinal edge of the diffusion band 38, this other edge being opposite to the edge forming the slots. To this end, the biological liquid can impregnate the mounting pads 44, 46 successively and gradually one after the other.

According to FIG. 2 and FIG. 3, the strip 30 is configured to be arranged in the housing bottom 24 along the longitudinal axis L. The lower face of the strip 30, that is to say the face of the strip 30 opposite to the face of the strip 30 on which the reactive elements 32, 34 are arranged, is arranged facing the housing bottom 24. In order to be able to perform a reading of the colour change of the reactive elements 32, 34 arranged on the upper face of the strip 30, the strip 30 is preferably a transparent strip 30, each reactive element 32, 34 of the strip being arranged, by transparency through the strip 30, facing an opening 52 of the housing bottom 24.

According to the first embodiment of FIG. 2 and FIG. 3, the opening 52 of the housing bottom 24 is a longitudinally extending opening 52, of a length along the longitudinal axis L slightly less than that of the strip 30 and of a width, in a direction transverse to the longitudinal axis L, slightly less than that of the strip 30, so that the strip 30 can bear on the periphery of the opening 52 of the housing bottom 24.

In order to be able to hold the strip 30 fixed against lateral movements, the strip 30 is configured to be arranged between a first lateral wall 51 of a first edge of the longitudinally extending housing bottom 24, and pins of lateral stop 53 of the strip 30 arranged on the housing bottom 24. In order to be able to hold the strip 30 fixed against translational movements along the longitudinal axis L, the strip 30 is configured to be arranged between a transverse wall 55 of the left end of the housing bottom 24 and another transverse wall 57, opposite to the transverse wall 55 of the left end of the housing bottom 24, arranged on the housing bottom 24. It should be noted that the strip 30 allows in particular holding the reactive elements 32, 34 fixed in the housing 16, and protecting the reactive elements 32, 34 against impurities outside the housing 16.

According to FIG. 2 and FIG. 3, the housing bottom 24 is configured to be able to hold the diffusion band 38 fixed both against the longitudinal movements and against lateral movements. To this end, the pins of lateral stop 53 of the strip 30 are configured to be arranged between slots or material recesses 48, 50 of the diffusion band 38. The edge of the diffusion band 38 not comprising any slots is configured to be arranged in abutment against a second lateral wall 59 of the second edge of the longitudinally extending housing bottom 24.

According to FIG. 2 and FIG. 3, the absorbent reservoir strip 36 is of a generally parallelepiped shape. The housing bottom 24 comprises a plurality of transverse support tabs 64 extending between each longitudinal edge of the housing bottom 24 and protruding inwardly of the housing 16. The transverse support tabs 64 of the plurality of transverse support tabs 64 are regularly spaced from the right lateral end 20 of the housing bottom 24 so as to be able to hold the absorbent reservoir band 36 in a balanced manner when closing the housing 16.

According to FIG. 2 and FIG. 3, the cover 26 of the housing 16 comprises a housing 54 configured to receive the absorbent reservoir band 36. The housing 54 is formed by a material reduction of the inner face of the cover 26. The housing 54 extends longitudinally from the right lateral end 20 of the cover 26 and is generally rectangular in shape allowing holding fixed, both against the translational movements along the longitudinal axis L, and against the lateral movements, the absorbent reservoir band 36. The housing 54 of the absorbent reservoir band 36 comprises an access opening 56 allowing directly accessing a portion of the absorbent reservoir band 36 from the outside of the housing 16 of the collection device 12. The portion of the absorbent reservoir band 36 arranged opposite to the access opening 56 forms a biological liquid deposition portion 37.

According to FIG. 2 and FIG. 3, the inner face of the cover 26 comprises bearing tabs 60 protruding on the inner face of the cover 26, the bearing tabs 60 extending longitudinally from the left lateral end 18 of the cover 26 to the housing 54 of the absorbent reservoir strip 36. The bearing tabs 60 form protruding patterns towards the inside of the housing 16, the tabs 60 being configured to bear on the diffusion band 38. In addition of the bearing tabs 60, the inner face of the cover 26 comprises bearing studs 62 configured to bear against the mounting pads 44, 46 of the diffusion band 38.

According to the first embodiment of FIG. 2 and FIG. 3, when the housing 16 is closed, that is to say when the periphery of the cover 26 is fixed with the periphery of the housing bottom 24, for example without limitation, by clipping, the absorbent reservoir strip 36 is in contact with the diffusion band 38, the diffusion band 38 is in contact with the reactive elements 32, 34. More particularly, when the housing 16 is closed, the inner surface of the housing 54 bearing on the absorbent reservoir band 36. The absorbent reservoir band 36 is therefore compressed between the inner surface of the housing 54 and the transverse tabs 64 such that the contact portion 40 of the absorbent reservoir band 36 is in bearing contact against the contact pad 42 of the diffusion band 38. To this end, in the case of depositing the biological liquid on the deposition portion 37 of the collection device 12, the biological liquid can diffuse from the absorbent reservoir strip 36 to the diffusion band 38.

When the housing 16 is closed, the longitudinal bearing tabs 60 exert a pressure on the diffusion strip 38 towards the housing bottom 24. In addition, when the housing 16 is closed, the bearing studs 62 exert a bearing force on the diffusion band 38, allowing a bearing contact of the mounting pads 44, 46 against the reactive elements 32, 34. The bearing force exerted by the longitudinal bearing tabs 60 associated with the bearing force exerted by the bearing studs 62 on the diffusion band 38, allows a reliable and durable contact of the mounting pads 44, 46 against the reactive elements 32, 34, thus allowing, in the case of presence of biological liquid on the diffusion band 38, a reliable reaction of the reactive elements 32, 34 with the biological liquid which can result in a colour change of the reactive elements 32, 34.

According to the first embodiment of the collection device 12 of FIG. 2 and of FIG. 3, it is advantageous that the strip 30, preferably transparent, can be flexible in order to be able to withstand the assembly stresses of the collection device 12. To this end, it is advantageous that the strip 30 is a strip 30 made of plastic material. Other material solutions, such as, for example, and in a non-limiting manner, the glass or even poly methyl methacrylate, could have been considered. For the purposes of automatically reading the colour change of the reactive elements 32, 34, that is to say, for example and without limitation, by assisted reading by an optical reading type technology, the strip 30 may not necessarily be transparent, but only allow the passage of light, like a translucent material. Alternatively to the first embodiment, the access opening 56 could also have been arranged on the housing bottom 24. Also, it could have been possible to provide a first access opening on the housing bottom 24 and a second access opening on the cover 26.

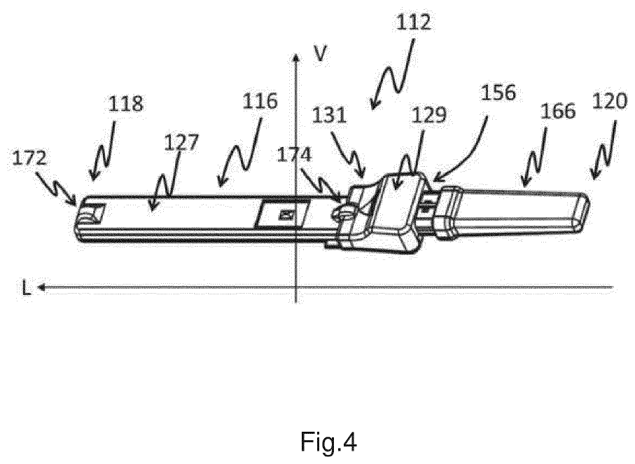

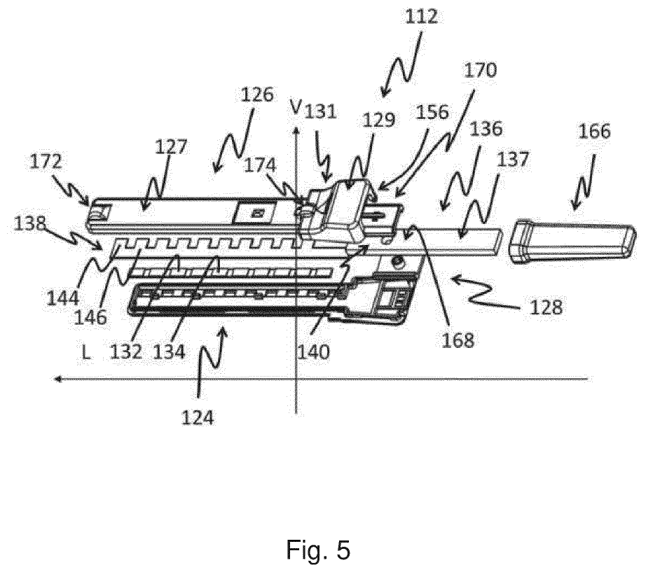

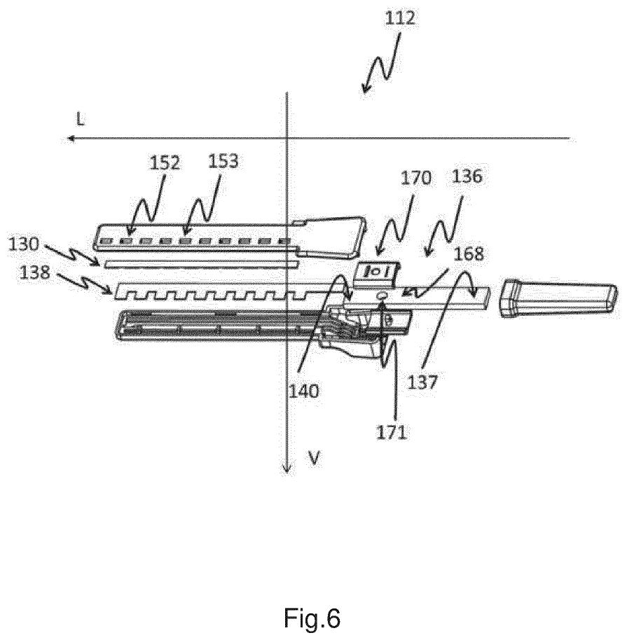

According to FIG. 4, FIG. 5 and FIG. 6, a second embodiment of a collection device 112 is represented. This second embodiment differs from the first embodiment in that the absorbent reservoir band 136 is no longer arranged in a housing of the cover 126 which is fixed against translational movements. The absorbent element 128 comprises an absorbent reservoir band 136 arranged through a lateral access opening 156 arranged on the right lateral face of the right lateral end 120 of the housing 116 such that the biological liquid deposition portion 137 of the absorbent reservoir band 136 is configured to be arranged outside the housing 116. The deposition portion 137 is advantageously configured to be covered by a cap 166 allowing manipulating the collection device 112 manually without having to grip the device 112 directly to the touch of the deposition portion 137 when it is inserted into the reader 14. According to this second embodiment, the absorbent reservoir band 136 is arranged so as to be able to be movable in translation along the longitudinal axis L.

More particularly and according to FIG. 5 and FIG. 6, the absorbent reservoir band 136 comprises, from the left end thereof to the right end thereof, successively, a contact portion 140 configured to be in contact with the diffusion band 138, a portion 168 for guiding in translation configured to be arranged in a guide ring 170, and the biological liquid deposition portion 137. The absorbent reservoir band 136 and the diffusion band 138 are arranged generally longitudinally one after the other generally similarly to the first embodiment.

The guide ring 170 is arranged secured to the guide portion 168 of the absorbent reservoir band 136. The guide ring 170 cooperates with guide rails extending inside the housing 116 from the lateral access opening 156. The guide ring 170 is configured to extend simultaneously inside the housing 116 so as to be partially arranged on the guide rails thereof and also partially outside the housing 116 so as to form a first end stop for the cap 166 when the latter is arranged in translation on the deposition portion 137.

More particularly, the guide ring 170 comprises an upper element and a lower element comprising respectively a male element such as a tenon and a female element, the portion 168 for guiding in translation the absorbent reservoir strip 136 comprising a fixing opening 171 allowing the passage of the female element of the lower element through the absorbent reservoir band 136 in order to allow the coupling of the two elements of the guide ring 170. The guide ring 170 is configured to hold the guide portion 168 during a translation of the absorbent reservoir band 136.

The cover 126 of the housing comprises a bearing section 127 arranged above the mounting pads 144, 146 of the diffusion band 138 and configured to come to bear on the mounting pads 144, 146 of the diffusion band 138 when closing the housing 116 for contacting the mounting pads 144, 146 with the reactive elements 132, 134. The cover 126 of the housing comprises a sliding section 129 arranged raised opposite to the bearing section 127 and configured for the translational sliding of the guide ring 170, the guide rails being arranged in this sliding section 129. The cover 126 comprises a sloping transition section 131 connecting the bearing section 127 and the sliding section 129. The contact pad 142 of the end of the diffusion band 138 is arranged at least partially below the transition section of the cover 126.

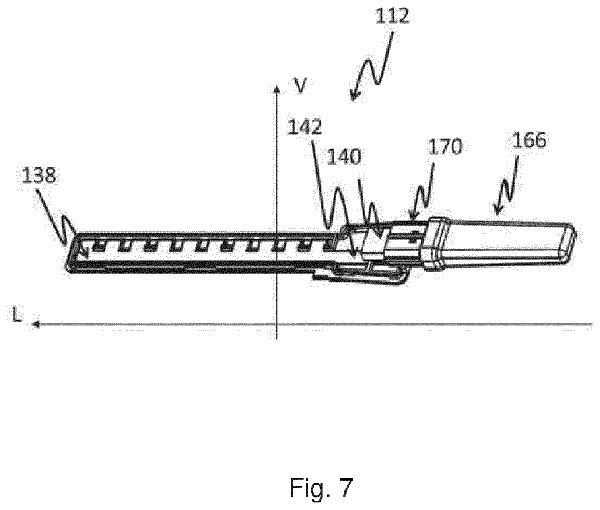

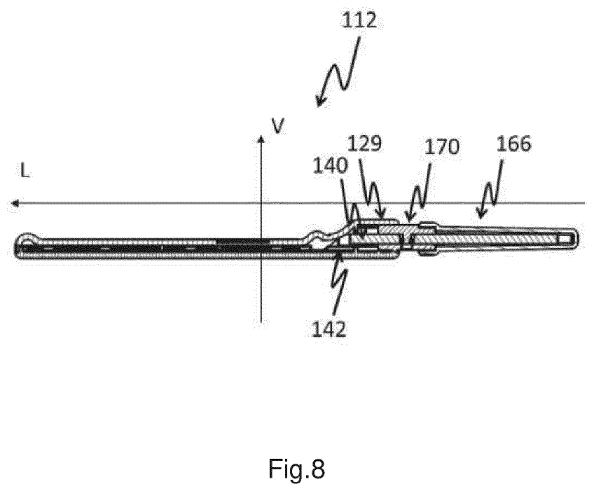

According to FIG. 7 and FIG. 8, the contact portion 140 of the absorbent reservoir band 136 is configured to be arranged out of contact with the contact pad 142 of the diffusion band 138 according to an initial position of the guide ring 170. According to this initial position, the guide ring 170 forms a first end stop for the cap 166 when it is arranged in translation on the deposition portion 137.

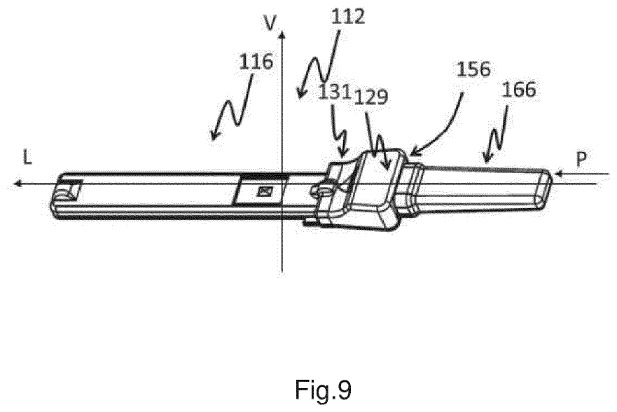

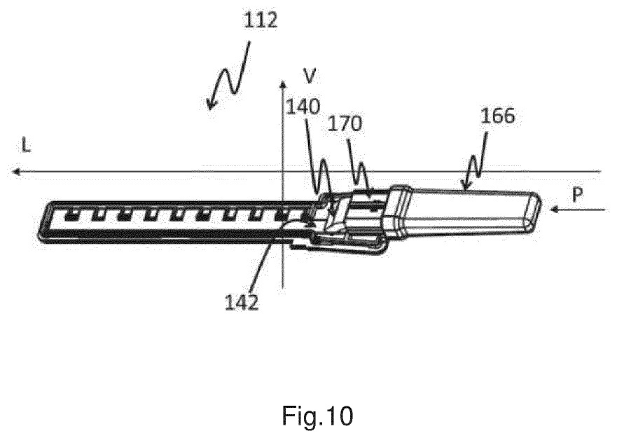

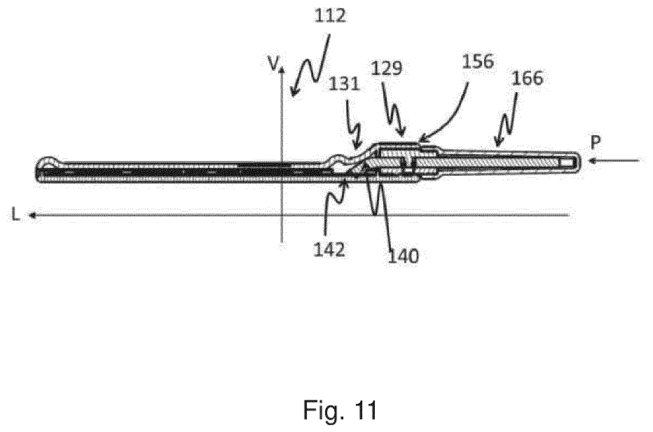

According to FIG. 9, FIG. 10 and FIG. 11, the guide ring 170 is configured to be slid in translation inwardly of the sliding section 129 by a pushing action P on the cap 166 until the cap 166 abuts on the outer periphery of the lateral access opening 156 of the housing 116, the periphery of the lateral access opening 156 forming a second end stop for the cap 166. During the translation of the guide ring 170, along the longitudinal axis L, inwardly of the sliding section 129, the contact portion 140 of the absorbent reservoir band 136 hits the inner surface of the transition section 131 of the cover 126 so as to be bent towards the contact pad 142 of the diffusion band 138. In other words, the inner surface of the transition section 131 is a pushing surface of the cover 126 for the contact portion 140 of the absorbent reservoir band 136. When the cap 166 abuts on the periphery of the lateral access opening 156, according to FIG. 10 and FIG. 11 the contact portion 140 of the absorbent reservoir band 136 is bent against the inner surface of the transition section 131 until it bears in contact with the contact pad 142 of the diffusion band 138.

Optionally, the sliding section 129 may comprise a detent-type immobilising means of the guide ring 170, the immobilising means being configured to immobilise the guide ring 170 when it is depressed by the guide cap 166 in the stop position against the second end stop. The immobilising means can advantageously only be operational until a certain extraction force exerted on the cap 166 or directly on the deposition portion 137. By way of non-limiting example, the immobilising means may comprise at least one boss on a guide rail such that the guide ring 170 must be inserted with an adequate force to override this boss. This boss can generate a tactile rendering of confirmation of effective insertion of the absorbent reservoir band 136 into the collection device 112 so as to ensure that the contact portion 140 of the absorbent reservoir band 136 is brought into contact with the contact pad 142 of the diffusion band 138.

According to FIG. 5 and FIG. 6, the second embodiment also differs from the first embodiment in that the housing bottom 124 comprises a plurality of housing bottom openings 152, 153 arranged one after the other along the longitudinal axis L. In order to be able to perform a reading of the colour change of the reactive elements 132, 134 arranged on the upper face of the strip 130, each reactive element 132, 134 of the strip 130 is arranged, by transparency through the strip 130, facing a single opening 152 of the housing bottom 124 different from another opening 154 of the housing bottom 124 associated with another reactive element 134. Although in accordance with the first embodiment, a single longitudinally extending housing bottom opening 124 could be suitable, the solution consisting of a plurality of openings 152, 154 in the housing bottom 124 allows strengthening the overall structure of the housing bottom 124.

According to FIG. 4 and FIG. 5, the second embodiment also differs from the first embodiment in that the upper surface of the cover 126 comprises a first boss 172 and a second boss 174, each boss 172, 174 protruding towards the outside of the housing 116. Advantageously, the first boss 172 is arranged in the vicinity of the free end of the bearing section 127 of the cover 126 so as to be vertically aligned with the left end of the diffusion band 138, the second boss 174 being arranged straddling between the transition section 131 of the cover 126 and the bearing section 127 of the cover 126. The first boss 172 and the second boss 174 allow guaranteeing a plane holding along the longitudinal axis L of the diffusion band 138 during its insertion into the portable reader 14 for analysing the biological liquid sample, the first boss 172 and the second boss 174 being inserted in friction with a wall of the reader 14 so as to exert pressure on the diffusion band 138. The first boss 172 and the second boss 174 also contribute to strengthen the contact between the mounting pads 144, 146 of the diffusion band 138 on the reactive elements 132, 134. It will be appropriate, that depending on the length along the longitudinal axis L of the diffusion band 138, a single boss or a plurality of bosses distributed over the upper surface of the cover 126 may also be suitable according to the invention. Globally, the first boss 172 and the second boss 174 allow pressing the collection device 112 on the base of the reader at the end of the stroke, the approach taking place with play.

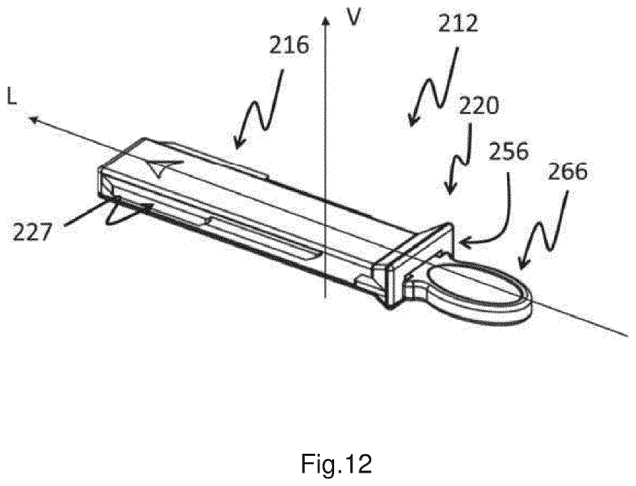

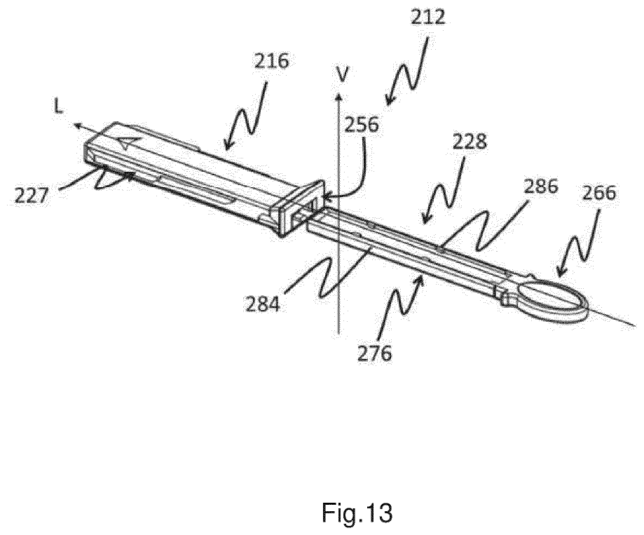

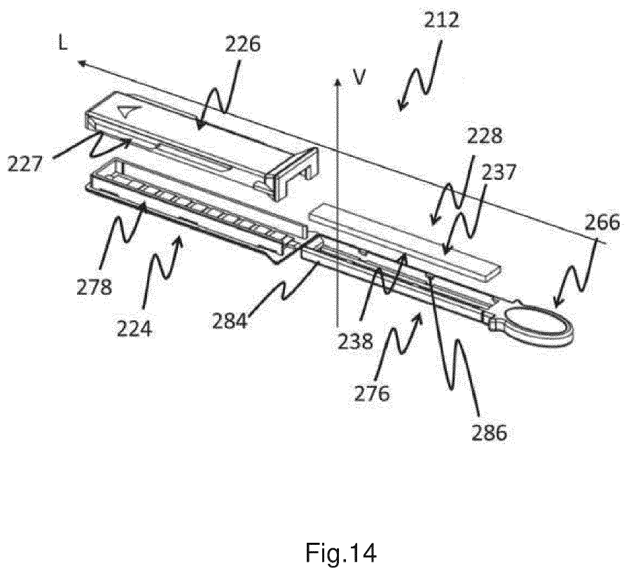

According to FIG. 12, FIG. 13 and FIG. 14, a third embodiment of a collection device 212 is represented. This third embodiment differs in particular from the first embodiment in that the housing 216 comprises a lateral access opening 256 arranged on the right lateral face of the right end 220 of the housing 216, similarly to the second embodiment. The collection device 212 comprises a handle 266 for manipulating the collection device 212 configured to be arranged in abutment against the periphery of the lateral access opening 256.

According to FIG. 13 and FIG. 14, the third embodiment differs from the second embodiment in that the manipulation handle 266 allows the complete insertion and extraction of the absorbent assembly 228 from the housing 216. In addition, particularly to the third embodiment, the collection device 212 comprises a removable support 276 of the absorbent assembly 228 configured to be inserted or extracted from the housing 216, the removable support 276 extending longitudinally from a first end comprising the manipulation handle 266 to the second end thereof configured to be inserted into the housing 216 through the lateral access opening 256.

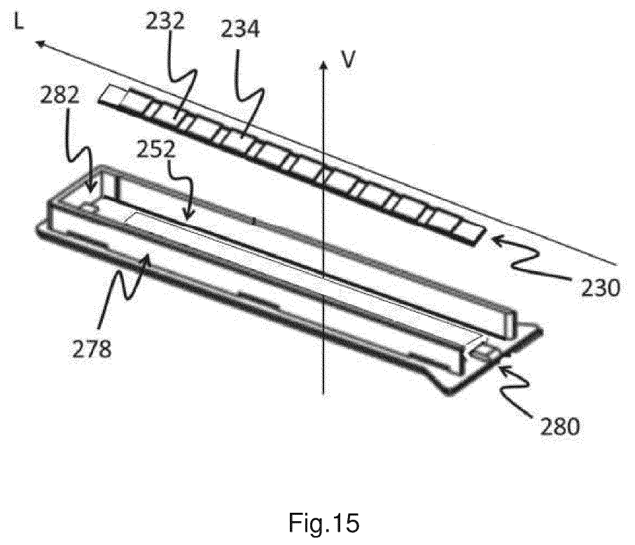

According to FIG. 14 and FIG. 15, the housing bottom 224 of the collection device 212 comprises two longitudinal walls which are opposite to each other and sufficiently spaced from each other so as to form a guideway 278 configured to guide the removable support 276 of the absorbent assembly 228 when it is inserted into the housing 216. The strip 230 comprising the reactive elements 232, 234 is configured to be arranged longitudinally at the bottom of the housing 224, each of the ends of the strip 230 being configured to be held in a notch 280, 282 of the housing bottom 224.

Optionally, the guideway 278 and the removable support 276 of the absorbent assembly 228 may comprise detent-type immobilising means of the removable support 276, so as to hold the absorbent assembly 228 stationary when the handle 266 for manipulating the removable support 276 abuts against the periphery of the lateral access opening 256 of the housing 216.

The face of the strip 230 not comprising any reactive elements 232, 234 is configured to be arranged to bear against the housing bottom 224 facing an extending longitudinally opening 252, of a length along the longitudinal axis L slightly less than that of the strip 30 and of a width, in a direction transverse to the longitudinal axis L, slightly less than that of the strip 230, such that the strip 230 can bear on the periphery of the opening 252 of the housing bottom 224.

According to FIG. 14, particularly to the third embodiment, the absorbent assembly 228 comprises a single absorbent element extending longitudinally and generally forming a parallelepiped element. The single absorbent element may be, for example without limitation, of the reservoir blotting paper type. The single absorbent element acts as a diffusion band 238 and also allows the deposition of biological liquid. In other words, the single absorbent element comprises a biological liquid deposition portion 237 and a diffusion band 238, the deposition portion 237 also being able to be used as a diffusion band 238.

According to FIG. 14, for the purposes of facilitating the manipulation of the removable support 276, the removable support 276 is configured to hold the absorbent assembly 228 on the periphery thereof so that the upper surface thereof and the lower surface thereof are directly accessible from above or below the removable support 276. To this end, the removable support 276 comprises lateral walls 284 for holding the absorbent assembly 228, each holding lateral wall 284 comprising flanges 286 bearing on the upper surface and on the lower surface of the absorbent assembly 228. To this end, the biological liquid deposition portion 237 can be also well defined on the upper or lower surface of the absorbent assembly 228 forming a single absorbent element, the diffusion band 238 being able to be itself identified as being either the top surface or the bottom surface of the absorbent assembly 228.

Optionally, it is possible to form, on one of the faces of the absorbent assembly 228, slot type patterns as illustrated on the diffusion band 38 of the first and second embodiments. To this end, a succession of areas which are reduced in thickness arranged successively along the longitudinal axis L on one face of the absorbent assembly 228 and each being separated by areas which are not reduced in thickness can form a diffusion band 238 in the form of a slot. The surface of the absorbent assembly 228 which is opposite to the diffusion band 238 can therefore be defined as the deposition portion 237, the biological liquid can diffuse from the surface acting as the deposition portion 237 to the surface acting as the diffusion band 238.

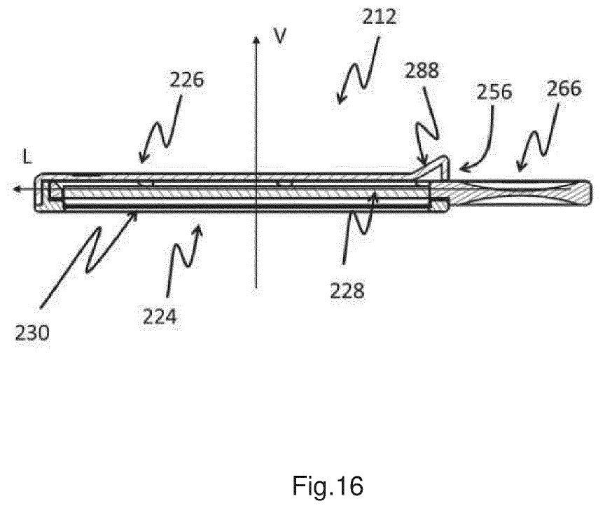

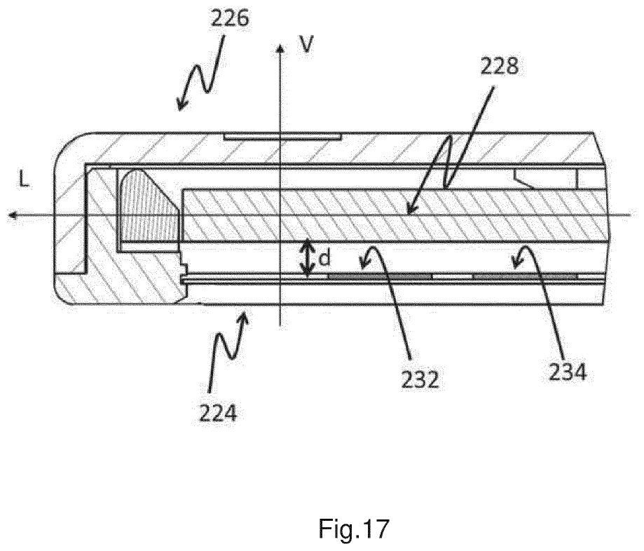

According to FIG. 16 and FIG. 17, according to the third embodiment, when the housing 216 is closed and the removable support 276 comprising the absorbent assembly 228 is entirely arranged in the housing 216, that is to say when the handle 266 abuts against the periphery of the lateral access opening 256, the absorbent assembly 228 is not in contact with the reactive elements 232, 234 of the strip 230. The distance d along the vertical axis V between the reactive elements 232, 324 and the surface of the absorbent assembly 228 forming the single absorbent element acting as a diffusion band 238 may be less than a millimetre, this distance d may correspond to the thickness along the vertical axis V of the flanges 286 of the holding lateral walls 284 of the absorbent assembly 228.

To this end, consequently, the collection device 212 does not allow, on its own, the biological liquid to be brought into contact with the reactive elements 232, 234. The collection device 212 of the third embodiment is configured so that the biological liquid only comes into contact with the reactive elements 232, 234 when this collection device 212 is inserted into the reader 14 for analysing the biological liquid sample.

To this end, according to FIG. 16, the cover 226 of the housing 216 comprises at the right end thereof, in the vicinity of the lateral access opening 256, a bevel type oblique sloping portion 288 extending upwardly from the cover surface 226 to the lateral access opening 256. This oblique sloping portion is configured to abut against a wall of the reader 14 so as to slide progressively in vertical thrust downwards the collection device 212 in contact with a stop internal to the analysis reader 14. Also, in order to bring the reactive elements 232, 234 into contact with the single absorbent element configured to diffuse the biological liquid on the reactive elements 232, 234, the internal stop of the analysis reader 14 is then configured to crush the strip 230 towards the absorbent assembly 228 during the vertical downward thrust of the collection device 12, the reactive elements 232, 234 of the strip 230 then being in compressed contact between the absorbent assembly 228 and the strip 230 arranged in direct contact with a protuberance of the base of the analysis reader 14. When the strip 230 is crushed, the two ends of the strip 230 are each ejected from the notch 280, 282 thereof of the housing bottom 224 of the collection device 212.

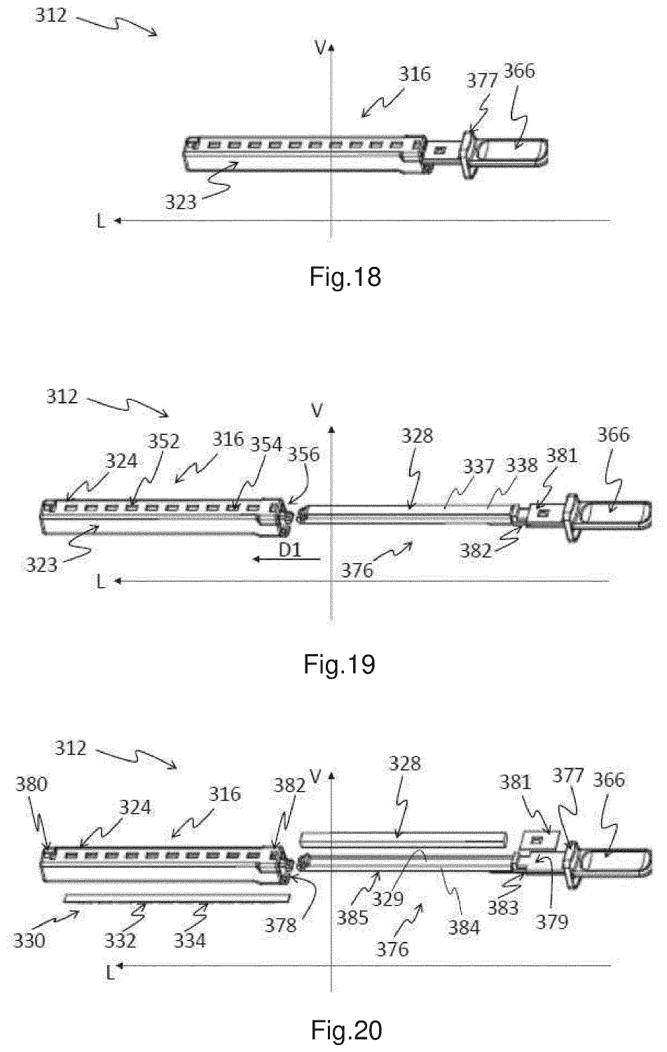

According to FIGS. 18, 19 and 20, a fourth embodiment of a collection device 312 is represented. This fourth embodiment is a variant of the third embodiment. The housing 316 comprises a lateral access opening 356 arranged on the right lateral face of the right end of the housing 316, similarly to the third embodiment. The collection device 312 comprises a manipulation handle 366 allowing the insertion in a longitudinal direction D1 and the extraction in a direction opposite to D1 complete of the absorbent assembly 328 of the housing 316. In addition, similarly to the third mode embodiment, the collection device 312 comprises a removable support 376 of the absorbent assembly 328 configured to be inserted or extracted from the housing 316, the removable support 376 extending longitudinally from a first end comprising the manipulation handle 366 to the second end thereof configured to be inserted into the housing 316 through the lateral access opening 356.

According to FIG. 19 and FIG. 20, the housing 316 of the collection device 312 comprises a housing top 324 and two longitudinal walls 323 which are opposite to each other and sufficiently spaced from each other so as to form a guideway 378 configured to guide the removable support 376 of the absorbent assembly 328 when it is inserted into the housing 316. The strip 330 comprising the reactive elements 332, 334 is configured to be arranged longitudinally at the housing top 324 between the two longitudinal walls 323 forming the guideway 378 of the removable support 376 of the absorbent assembly 328, each of the ends of the strip 330 being configured to be held in a notch 380, 382 of the housing top 324. It will be appropriate according to the invention, that the designation of the housing top or the housing bottom of the device for collecting the biological liquid can be considered as equivalent, the overall orientation of the collection device and the reader of the device being indications. These names simply allow an intuitive and clear description of the figures illustrating the invention. More generally, none of the described overall orientations of the collection device is a limiting constraint on the invention.

Optionally, the guideway 378 and the removable support 376 of the absorbent assembly 328 can comprise detent-type immobilising means of the removable support 376, so as to hold the absorbent assembly 328 stationary when the removable support 376 abuts against the periphery of the lateral access opening 356 of the housing 316.

The removable support 376 comprises respectively, from the first end thereof to the second end thereof, the manipulation handle 366 delimited by a guard element 377 preferably of trapezoidal shape and configured to close the opening of the reader housing in which it is provided to introduce the biological collection device 312, then a mounting pad 379 configured to arrange therein an electronic identification tag 381 and forming a stop 383 of the removable support 376 against the housing 316 of the collection device 312, and finally a support portion 385 of the absorbent assembly 328. The support portion 385 comprises a tab 329 for supporting the absorbent assembly 328, that is to say a tab 329 on which the absorbent assembly 328 rests, the support tab 329 may comprise lateral walls 384 allowing the holding of the absorbent assembly 328 on the tab 329. The housing 316 of the collection device 312 not comprising a housing bottom, when the removable support 376 is inserted into the housing 316 of the collection device 312, the support tab 329 of the absorbent assembly 328 acts as a housing bottom of the collection device 312.

In a manner comparable to the third embodiment, the face of the strip 330 comprising no reactive elements 332, 334 is configured to be arranged in abutment against the housing top 324 opposite a plurality of openings 352, 354 in the housing top 324. More particularly, in order to be able to perform a reading of the colour change of the reactive elements 332, 334 arranged on the strip 330, each reactive element 332, 334 of the strip 330 is arranged, by transparency through the strip 330, facing a single opening 352 of the plurality of openings in the housing top 324, this single opening 352 being different from another opening 354 in the housing top 324 associated with another reactive element 334.

According to FIG. 19 and FIG. 20, in a manner comparable to the third embodiment, the absorbent assembly 328 comprises a single absorbent element extending longitudinally and generally forming a parallelepiped element. The single absorbent element 328 may be, for example without limitation, of the reservoir blotting paper type. The single absorbent element 328 acts as a diffusion band 338 and also allows the deposition of the biological liquid. In other words, the single absorbent element 328 comprises a biological liquid deposition portion 337 and a diffusion band 338, the deposition portion 337 acting as a diffusion band 338.

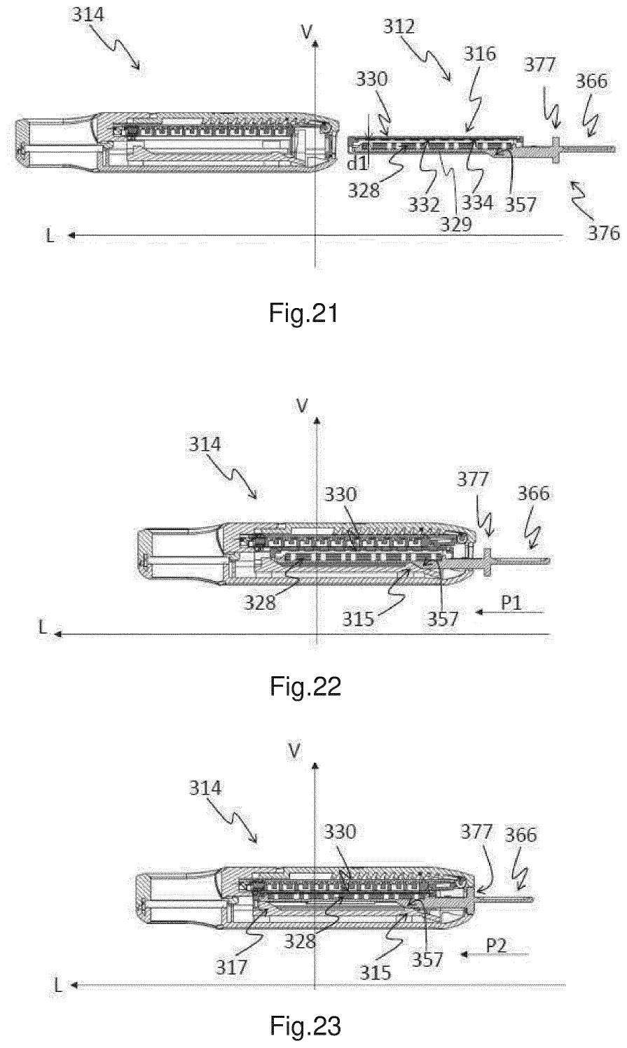

According to FIG. 21, a transparent longitudinal section of the collection device 312 and of a reader 314 for analysing the biological liquid sample according to the fourth embodiment is represented. When the housing 316 is closed, that is to say when the removable support 376 comprising the absorbent assembly 328 is arranged in abutment into the housing 316, the absorbent assembly 328 is not in contact with the reactive elements 332, 334 of the strip 330. The distance dl along the vertical axis V between the reactive elements 332, 324 and the surface of the absorbent assembly 328 acting as the diffusion band 338 may be less than a millimetre.

To this end, consequently, the collection device 312 does not on its own allow the biological liquid to be brought into contact with the reactive elements 332, 334. The collection device 312 of the fourth embodiment is configured so that the biological liquid only comes into contact with the reactive elements 332, 334 when this collection device 312 is inserted into the reader 314 for analysing the biological liquid sample.

To this end, according to FIG. 21, the right end of the support tag 329 of the absorbent assembly 328 comprises a bevelled portion 357 of a thickness, along the vertical axis, greater than the rest of the support tab 329, the bevelled portion comprising a downward slope towards the mounting pad 379 of the identification label 381.

According to FIG. 22, when the introduction according to a first push P1 of the collection device 312, the bevelled portion 357 is configured to abut on a first embossment 315 of the sample analysis reader 314 before its complete insertion into the sample analysis reader 314, that is to say, before the guard element 377 closes the opening of the housing of the sample analysis reader 314. At this point, the absorbent assembly 328 is not in contact with the reactive elements 332, 334 of the strip 330.

According to FIG. 23, when the insertion of the collection device 312 goes beyond the stop formed by the first embossment 315 of the housing of sample analysis reader 314, that is to say during a second push P2 of the collection device 312 until closing the opening of the housing of the sample analysis reader 314 by the guard element 377 of the collection device 312, the bevelled portion 357 is arranged over the top of the first embossment 315 and causes the raising of the support tab 329 of the absorbent assembly 328 towards the reactive elements 332, 334 of the strip 330 so as to bring the absorbent assembly 328 into contact with the reactive elements. More particularly, when the bevelled portion 357 is pushed over the top of the first embossment 315, the opposite longitudinal walls 323 forming the guideway 378 of the removable support 376 move away from each other so as to release the removable support 376 of the guideway 378, the removable support 376 being pushed by the first embossment 315 in the direction of the reactive elements 332, 334 of the strip 330.

It should be noted that the sample analysis reader 314 may comprise a second embossment 317 configured to also raise the free end of the support tab 329 of the absorbent assembly 328 towards the reactive elements 332, 334 of the strip 330 and therefore improve the contact between the absorbent assembly 328 towards the reactive elements 332, 334 of the strip 330.

Commonly to the four described embodiments, each housing 16, 116, 216, 316 of each collection device 12, 112, 212, 312 may also comprise a lug arranged on a wall of the housing 16, 116, 216, 316 so as to form a detection stop cooperating with a position sensor of the analysis reader 14, 314, thus allowing the analysis reader 14, 314 to control the presence or absence of the collection device 12, 112, 212, 312 which is correctly arranged in the analysis reader 14, 314.

Also in a manner common to the four described embodiments, each housing 16, 116, 216, 316 of each collection device 12, 112, 212, 312 can comprise an electronic identification label arranged for example glued on the cover 26, 126, 226, or even according to the fourth embodiment, glued on the removable support 376, so as to guarantee a traceability of each collection device 12, 112, 212.

Also commonly with the four described embodiments, as illustrated in FIGS. 12, 13 and 14, the housing 216, more particularly the upper cover 226 of the housing may also comprise lateral guide fins 227 allowing facilitating the insertion of the collection cartridge in the analysis reader 14, 314. The guide fins 227 are configured to be able to cooperate with guide means specific to the analysis reader 14, 314.

It should be noted that according to the four described embodiments of the collection devices 12, 112, 212, 312, the analysis reader 14, 314 of FIG. 1 can comprise several variants so as to be compatible with each of the embodiments. A non-limiting example is illustrated in FIGS. 21, 22 and 23.

It should be noted that the four described embodiments are particularly suitable for an optical reading by reflection of light on each reactive element 32, 132, 232, 332 through the openings 52, 152, 252, 352 in the housing bottom 24, 124, 224, or the housing top 324 and the strip 30, 130, 230, 330 allowing the detection, by the analysis reader 14, 314, of a colour change of the reactive elements 32, 132, 232, 332 and therefore allowing the automatic analysis by the reader 14 of the properties of the sample of the biological liquid to be analysed.

It should be noted that the invention is particularly advantageous for the analysis of biological liquid of the urine type. The colour-changing reactive elements 32, 132, 232, 332 into contact with urine can, for example and without limitation, provide information relating to the supervision of the acidity of urine via its hydrogen potential, denoted pH, or even the urinary density and the creatinine concentration thereof. The uric acid concentration is also a possible supervision factor.

It should of course be understood that the detailed description of the subject of the invention, given solely by way of illustration, does not in any way constitute a limitation, the technical equivalents also being comprised within the scope of the present invention.

1-10. (canceled)

11. A device to collect a sample of a biological liquid to be inserted into a portable reader to analyze the biological liquid, the device comprising:
a transparent or translucent strip extending along a longitudinal axis and comprising, on an upper face of the strip, a plurality of color-changing reactive elements arranged one after the other along the longitudinal axis;
an absorbent assembly extending along the longitudinal axis and comprising: a biological liquid deposition portion and a diffusion band to diffuse the biological liquid arranged over a top of the plurality of color-changing reactive elements;
a housing extending along the longitudinal axis between two lateral ends, the housing comprising:
a housing bottom, the strip being arranged on the housing bottom, a lower face of the strip being arranged facing the housing bottom, each reactive element being arranged by transparency through the strip facing an opening of the housing bottom;
a cover arranged over a top of the diffusion band, and comprising at least one protruding pattern forming a first pressing surface configured to press the diffusion band into contact with the plurality of color-changing reactive elements; and
an access opening configured to provide access to the biological liquid deposition portion.

12. The device of claim 11, wherein the biological liquid deposition portion is arranged through the access opening.

13. The device of claim 11, wherein the absorbent assembly is a single blotting paper.

14. The device of claim 11, wherein the biological liquid deposition portion comprises an absorbent reservoir band distinct from the diffusion band; and wherein the housing comprises a second pressing surface configured to press at least one contact portion of the absorbent reservoir band into contact with a contact pad of the diffusion band.

15. The device of claim 14, wherein the absorbent reservoir band and the diffusion band are arranged longitudinally one after the other, the reservoir band being configured to be movable in translation along the longitudinal axis; and wherein said at least one contact portion is arranged at an end of the absorbent reservoir band, said at least one contact portion being configured to hit the second pressing surface by pushing, along the longitudinal axis, of the absorbent reservoir band and into contact with the contact pad of the diffusion band.

16. The device of claim 14, wherein the diffusion band and the absorbent reservoir band respectively comprise a diffusion blotting paper and a reservoir blotting paper distinct from the diffusion blotting paper, the reservoir blotting paper comprising a liquid absorption feature greater than that of the diffusion blotting paper.

17. The device of claim 11, wherein the diffusion band comprises a plurality of mounting pads arranged successively along the longitudinal axis, each reactive element being arranged under a single mounting pad, the diffusion band comprising a material recess between each of the mounting pads.

18. The device of claim 11, wherein the access opening is arranged on one of lateral ends of the housing.

19. The device of claim 18, wherein the housing comprises two opposite longitudinal walls inside the housing forming a guideway cooperating with a removable support of the absorbent assembly, the removable support being configured to be inserted into the housing through the access opening.

20. The device of claim 11, wherein the access opening is arranged on the cover of the housing or on the housing bottom.
